(19) United States
(12) Patent Application Publication
(10) Pub. No.: US 2008/0272877 A1
(43) Pub. Date: Nov. 6, 2008

(54) Fuse Device

(75) Inventor: Seog-Ha Kwon, Seoul (KR)

Correspondence Address: PATENT LAW GROUP LLP, 2635 NORTH FIRST STREET, SUITE 223, SAN JOSE, CA, 95134, US

(73) Assignee: ALPI CO., LTD, Gyeonggi-Do (KR)

(21) Appl. No.: 11/570,720

(22) PCT Filed: Jun. 18, 2004
(86) PCT No.: PCT/KR04/01469

§ 371 Date: Feb. 12, 2007

(30) Foreign Application Priority Data
Jun. 18, 2004 (WO) PCTKR2004001469

(51) Int. Cl. H01H 85/04

(52) U.S. Cl. 337/198

(57) ABSTRACT

A fuse device is disclosed for automatically disconnecting an electric line at the occurrence of over-current condition. The fuse device comprises: a fuse having an insulating base, a pair of lead wires affixed to the base in a spaced-apart relationship with each other, a fusible member interconnecting the lead wires and a cap coupled to the base for enclosing the fusible member; a holder for removably retaining the fuse in place, the holder having a pair of through-holes in alignment with the lead wires of the fuse; and, a pair of receptacle terminals respectively fitted into the through-holes of the holder for receiving the lead wires of the fuse, each of the receptacle terminals having a leg connectable to a printed circuit board.

### FIELD OF THE INVENTION

The present invention relates to a fuse device for automatically disconnecting an electric line at the occurrence of over-current condition or the like, and in particular to a fuse device which allows simple and easy replacement of a fuse with a new one.

### BACKGROUND ART

As known in the art, fuses are a kind of protection devices for protecting an electronic component or an electric circuit from over-current and have been developed in various constructions and types, in which a fusible member is subject to fusion-cut, that is, a fusible member is heated, fused and thus cut when variation of voltage, short-circuit, and/or over-current are occurred, thereby automatically disconnecting an electric line to automatically cut off an electric circuit.

A typical fuse comprises a wire-shaped fusible member received within a relatively long glass tube at the center thereof, and a pair of caps provided at the opposite ends of the glass tube, the opposite ends of the fusible member being respectively connected to the covers. The caps are respectively fitted into and connected to a pair of receptacle terminals mounted on a printed circuit board. The tube type fuse with this construction has a disadvantage in that it is large-sized and occupies an increased space, thereby making it difficult for the fuse to be employed in a compact electronic product.

Referring to the construction of a conventional fuse disclosed in Korean Utility Model Publication No. 20-172819 by way of an example, a pair of lead wires of the fuse vertically extend through an insulating base having a circular plate shape and are opposed to each other, and a fusible member formed by a coiled thin wire is connected to the top ends of the lead wire. In addition, the fusible member is received within a cylindrical cap coupled to the base and the lower ends of the lead wires exposed from the bottom of the base are connected to a printed circuit board by soldering. The conventional fuse disclosed in the Korean Utility Model Publication has an advantage in that it can be fabricated in a compact size, thereby being mounted in a narrow space on a printed circuit board in a simple and convenient manner.

However, such a conventional fuse has a problem in that a lot of time and effort are required to replace the fuse with a new one when the fusible member is disconnected due to the occurrence of over-current or the like. Specifically, the fuse has a disadvantage in that it is very troublesome and inconvenient to replace the fuse with a new one, because it is needed to melt the solder on the lead wires and the printed circuit board to remove the fuse from the printed circuit board, and then to reconnect the lead wires of a new fuse to the printed circuit board by soldering. Moreover, an electronic circuit on the printed circuit board is very liable to be shorted or an electronic component or device may be damaged due to an error of an operator when melting the solder on the lead wires and the printed circuit board or soldering the lead wires and the printed circuit board. In addition, explosive force may be produced within the sealed space of the cap as the fusible member is disconnected; a problem may be also accompanied in that the cap gets out from the base if the cap is fractured by the explosive force. There is also a problem in that it is difficult to identify by the naked eyes the disconnection of such a fusible member which is very thin and contained within the cylindrical cap.

### DISCLOSURE OF THE INVENTION

Accordingly, the present invention has been made to solve the above-mentioned problems inherent in the prior art, and an object of the present invention is to provide a fuse device that permits a damaged fuse to be changed easily with a new one.

Another object of the present invention is to provide a fuse device having a holder for rigidly retaining a fuse mounted therein.

Yet, another object of the present invention is to provide a fuse device, wherein a cap is efficiently prevented from getting out from a base of a fuse, thereby highly enhancing the reliability.

Still yet, another object of the present invention is to provide a fuse device, wherein the disconnection of a fusible member can be easily identified.

According to a preferred embodiment of the present invention, there is provided a fuse device comprising: a fuse having an insulating base, a pair of lead wires affixed to the base in a spaced-apart relationship with each other, a fusible member interconnecting the lead wires and a cap coupled to the base for enclosing the fusible member; a holder for removably retaining the fuse in place, the holder having a pair of through-holes in alignment with the lead wires of the fuse; and a pair of receptacle terminals respectively fitted into the through-holes of the holder for receiving the lead wires of the fuse, each of the receptacle terminals having a leg connectable to a printed circuit board.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view showing the inventive fuse device in a disassembled state;

FIG. 2 is a cross-sectional view showing the inventive fuse device in a disassembled state;

FIG. 3 is a perspective view showing the inventive fuse device in an assembled state;

FIG. 4 is a cross-sectional view showing the inventive fuse device in an assembled state;

FIG. 5 is a cross-sectional view showing the inventive fuse device, in which another type of a fuse is shown;

FIG. 6 is a perspective view showing the inventive fuse device, in which other types of a fuse, a holder and receptacle terminals are shown in a disassembled state; and

FIG. 7 is a cross-sectional view showing the fuse, holder and receptacle terminals in an assembled state.

### BEST MODE FOR CARRYING OUT THE INVENTION

Hereinafter, preferred embodiments of the present invention will be described with reference to the accompanying drawings.

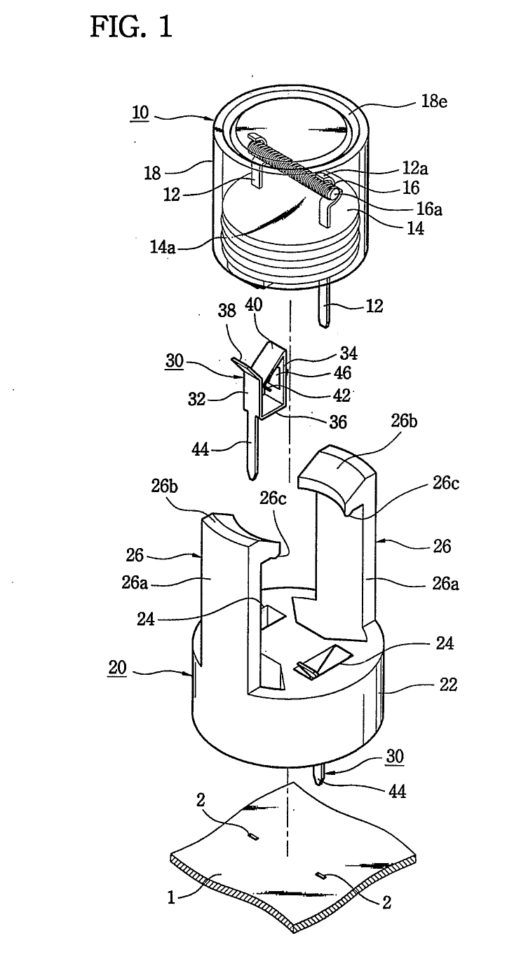

Firstly, referring to FIGS. 1, 2 and 4, the fuse 10 of the inventive fuse device 10 comprises two conductive lead wires 12 which are spaced from each other and arranged parallel to each other, in which the two lead wires 12 are vertically extend through and affixed to a disc shaped insulating base 14. Each lead wire 12 is formed with a connection part 12a, and the base 14 is formed with one or more engaging projections 14a extending along the circumferential direction of the base 14. The two lead wires 12 and the base 14 may be fabricated by a conventional insert molding process, through which the base 14 is integrally molded to the two lead wires 12 at substantially longitudinally central areas of the two lead wires 12. Each lead wire 12 is formed with an embedded projection at the central area where the base 14 is molded in order to prevent the insert-molded base 14 from being separated. In this embodiment, it is also possible to assemble a base 14 and two lead wires 12 by forming two through-holes through the base 14 and then fitting by pressure the two lead wires 12 into the through-holes, respectively.

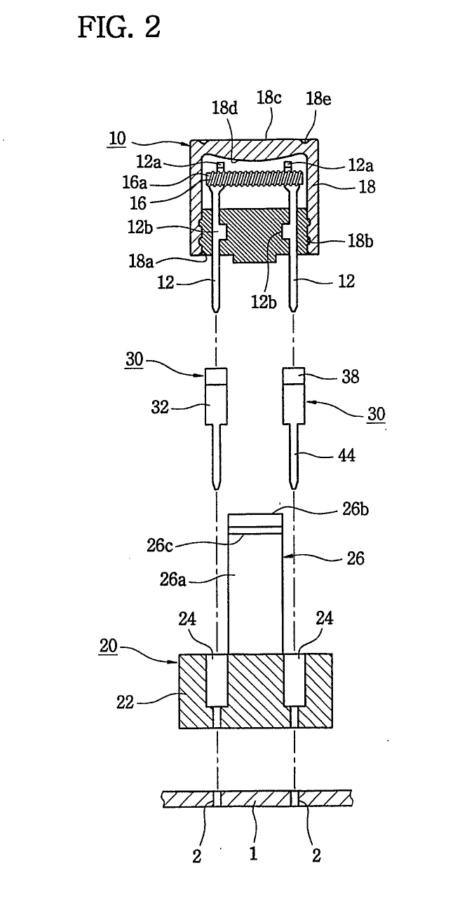

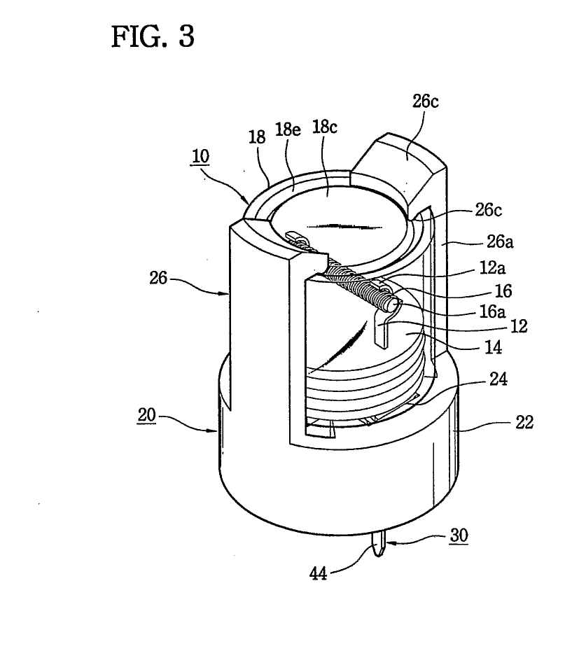

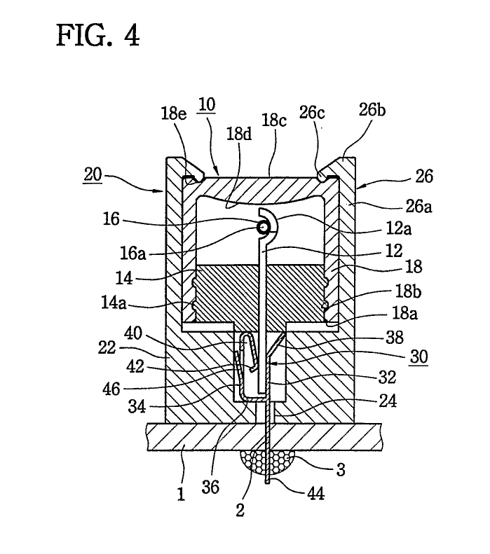

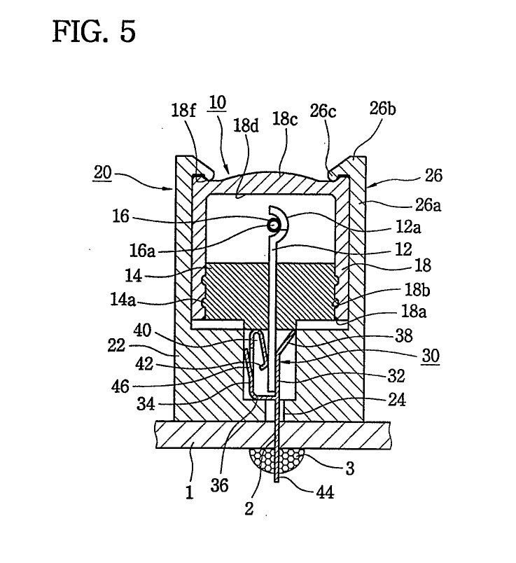

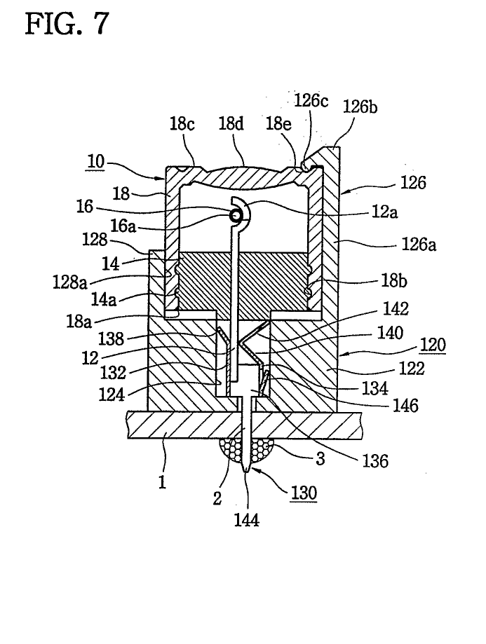

In addition, as shown in detail in FIGS. 2 and 4, opposite ends of a fusible body 16 are engaged with the connection parts 12a of the two lead wires 12, in which the fusible body 16 will be cut off by variation of voltage, short-circuit, application of over-current or the like. The fusible member 16 may be fabricated by winding a thin wire along the circumferential surface of a glass fiber 16a in a coil shape. Alternatively, it is also possible to form such a fusible body 16 using a thin conductive wire only. A transparent cylindrical cap 18 with an open end 18a is fitted onto the circumferential surface of the base 14 at the open end 18a, so that the fusible member 16 can be received within the cap in a state in which the fusible member 16 is connected to the two lead wires 12, and one or more engaging recesses 18b are formed on the inner circumferential surface of the cap 18 adjacent to the open end 18a, so that the one or more connection projections 14a on the base 14 can be respectively fitted by pressure into the engaging recesses 18b. The closed end 18c of the cap 18 is formed with a lens 18d, so that the fusible member 16 can be magnified with the lens 18b and viewed through the closed end 18c. FIGS. 2 and 4 show a plano-convex lens formed on the bottom of the closed end 18c of the cap 18, FIG. 5 shows a plano-convex lens formed of the top of the closed end 18c, and FIG. 7 shows a convex lens. As shown in FIGS. 1 to 4, latch grooves 18e are formed on the top of the closed end 18c of the cap 18 as locking means. Alternatively, latch projections 18f may be formed on the top of the closed end 18c of the cap as locking means.

Referring to FIGS. 1 to 3, the inventive fuse device includes a holder 20 for removably retaining the fuse 10 in place. The holder 20 has a cylindrical body 22 formed with two through-holes 24 of rectangular cross-section, in which the two through-holes 24 are in alignment with two holes 2 formed through the printed circuit board 1 and the two lead wires 12 of the fuse 10, respectively. The top edge of the cylindrical body 22 is formed with a plurality of snap hooks 26 latched to the top of the cap 18, thereby holding the fuse 10.

Referring to FIGS. 1 to 5, each snap hook 26 comprises an elastic stem 26a vertically extending from the top of the body 22 to have elasticity, and a head 26b formed at the top end of the elastic stem 26a and having a shape adapted to be latched to the top of the cap 18. The elastic stem 26a is formed in an arc shaped cross-section, so that the elastic stem 26a can wrap and support the external surface of the cylindrical cap 18; the elastic stem 26a is formed with a latch projection 26c at the front end of the bottom side of the head 26b, wherein the latch projection 26c corresponds to and engaged with a latch groove 18e or a latch ridge 18f formed on the cap 18. Although the drawings show two snap hooks 26 arranged opposite to each other, the number and positions of the snap hooks 26 can be properly modified as required.

Meanwhile, the inventive fuse device comprises two receptacle terminals 30 inserted into the two through-holes 24 formed through the holder 20, respectively, so that the terminals 20 can be electrically connected to the lead wires 12 of the fuse 10. Each receptacle terminal 30 comprises a first vertical section 32 and a second vertical section 34, which vertically extend parallel to each other, and a horizontal section 36 extending between the bottom ends of the first and second vertical sections 32, 34, so that the first and second vertical section 32, 34 and the horizontal section 36 form a “U” shape. The first and second vertical sections 32, 34 of the receptacle terminal 30 are respectively fitted by pressure into the through-holes 24 of the holder 20 in order to prevent them from getting away from the through-hole 24.

The first vertical section 32 has a first guide piece 38 formed at and outwardly inclined from the top end of the first vertical section 32, so that the first guide piece 38 can guide a lead wire 12 of the fuse 10 inserted between the first and second vertical sections 32, 34, and the second vertical section 34 has a second guide piece 40 formed at and inwardly inclined from the top end of the second vertical section 34, so that the second guide piece 40 can guide a lead wire 12 of the fuse 10 inserted between the first and second vertical sections 32, 34. The first and second guide pieces 38, 40 of the receptacle terminal 30 form a “V” shape, so that they can smoothly guide the insertion of the lead wire 12. The tip end of the second guide piece 40 may be bent to form a bent piece 42 which is in contact with or spaced from the inner surface of the first vertical section 34 by a space narrower than the thickness of the lead wire 12. The bottom end of the first vertical section 34 is connected to a leg 44 with a predetermined length extending beyond the bottom of the holder 20 so that the leg 44 can be connected to a connection hole 2 formed in the printed circuit board 1 by solder 3 soldered thereto. Alternatively, the leg 44 may extend from the bottom end of the second vertical section 34. In addition, a latch piece 46 is bent from the second vertical section 34 of the receptacle terminal 30 so that it can be elastically deformed by closely contacting with the inner surface of the through-hole 24 of the holder 20. In the present embodiment, it is possible to substitute the latch piece 46 with a projection which projects in a triangular or circular shape from the outer side of the second vertical section 34 and comes into close contact with the inner surface of the through-hole 24 of the holder 20.

FIGS. 7 and 8 show another embodiment of the holder 120 having a body 122, two through-holes 124, and one snap hook 126, in which the snap hook 126 comprises an elastic stem 126a, a head 126b and a latch projection 126c. The body 122, the two through-holes 124 and the snap hook 126 of the holder 120 are basically same with the body 22, the two through-holes 24 and the snap hook 126 of the afore-mentioned holder 20 in terms of construction and function, and thus detailed description thereof will be omitted. The holder 120 is provided with a skirt 128 extending from the edge of the body 122, thereby forming a mounting space 128a for receiving the cap 18 of the fuse 10.

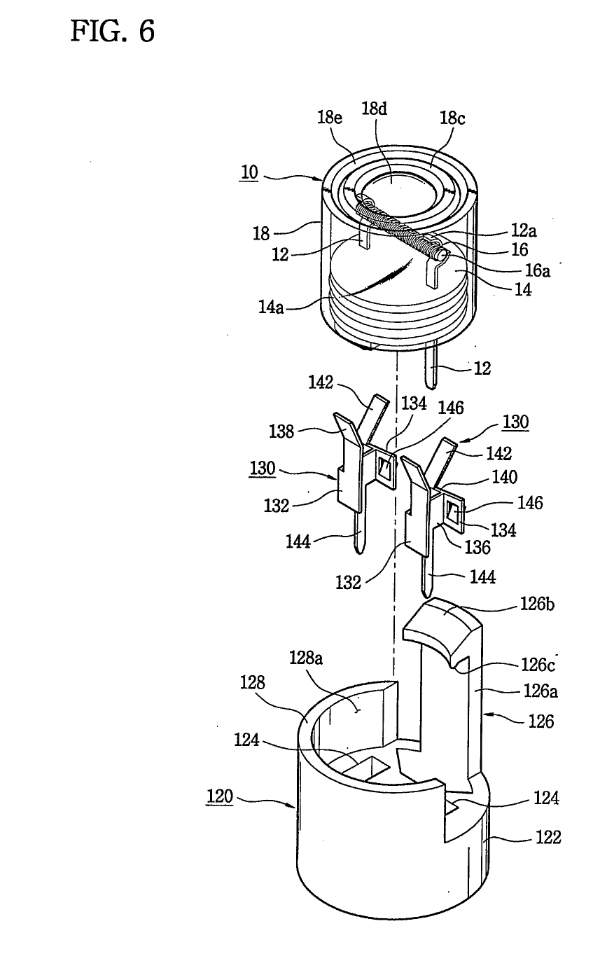

In addition, FIGS. 6 and 7 show another example of the two receptacle terminals. Referring to FIGS. 6 and 7, each receptacle terminal 130 comprises a first vertical section 132 and a second vertical section 134, which vertically extend parallel to each other, and a horizontal section 136 extending between the bottom ends of the first and second vertical sections 132, 134, so that the first and second vertical section 132, 134 and the horizontal section 136 form a “U” shape. The first and second vertical sections 132, 134 of the receptacle terminal 130 are respectively fitted by pressure into the through-holes 124 of the holder 120 in order to prevent them from getting away from the through-holes 124.

The first vertical section 132 has a first guide piece 138 formed at and outwardly inclined from the top end of the first vertical section 132, so that the first guide piece 138 can guide a lead wire 12 of the fuse 10 inserted between the first and second vertical sections 132, 134. The second vertical section 134 has a bent piece 140 bent at the top end of the second vertical section 134 and inclined toward the first vertical section 134, and a second guide piece 142 bent at the tip end of the bent piece 140 and outwardly inclined. The first and second guide pieces 138, 142 of the receptacle terminal 130 form a “V” shape, so that they can smoothly guide the insertion of the lead wire 12. The bent point between the first vertical section 132 and the first guide piece 138 and the bent point between the bent piece 140 and the second guide piece 142 of the receptacle terminal 130 are designed in such a way that they are spaced by a distance narrower than the thickness of the lead wire 12 to be contacted thereto. The horizontal section 136 is formed with a leg 144 at the center of the horizontal section 136, in which the leg 144 has a predetermined length extending beyond the bottom of the holder 120, so that the leg 144 can be connected to a connection hole 2 formed in the printed circuit board 1 by solder 3 soldered thereto. In addition, a latch piece 146 is bent from the second vertical section 134 of the receptacle terminal 130 so that it can be elastically deformed by closely contacting with the inner surface of the through-hole 124 of the holder 120. Although the receptacle terminals 130 are shown as being inserted into the two through-holes 124 of the holder 120 from the upper side of the holder 120 in FIGS. 6 and 7, it is also possible to construct the holder 120 and the receptacle terminals 130 in such a way that the receptacle terminals 130 can be inserted into the through-holes 124 from the lower side of the holder 120.

Now, the functional action of the inventive fuse device constructed as above will be described.

Referring to FIGS. 1, 2 and 4, an operator firstly fits by pressure the first and second vertical sections 32, 34 of the receptacle terminals 30 into the two through-holes 24 of the holder 20, respectively. As such, the latch pieces 46 of the second vertical sections 34 closely contacts with the inner surfaces of the corresponding through-holes 24, thereby certainly preventing the receptacle terminals 30 from getting away from the through-holes 24 of the holder 20. Then, the operator inserts the legs 44 of the receptacle terminals 30 projecting through the two through-holes 24 of the holder 20 into the connection holes 2 formed in a printed circuit board 1. In addition, the operator rigidly connects the terminal ends of the legs 44 projecting through the connection holes 2 of the printed circuit board 1 by solder 3 soldered thereto.

Next, if the operator inserts the fuse 10 between the plural snap hooks 26 from the upper side of the holder 20, the elastic stems 26b are opened outwardly while being elastically deformed, thereby allowing the fuse 10 to be smoothly inserted. Each lead wire 12 of the fuse 10 is inserted between the first vertical section 32 and the bent piece 42 of a corresponding receptacle terminal 30 while being guided by the first and second guide pieces 38, 40 of the receptacle terminal 30, and the second guide piece 40 is elastically deformed toward the second vertical section 34, thereby allowing the lead wire 12 to be smoothly inserted.

In addition, as shown in FIGS. 2 and 4, if the operator inwardly pushes the heads 26b of the snap hooks 26 after the insertion of the fuse 10 between the snap hooks 26 of the holder 20 is completed, the elastic stems 26a of the snap hooks 26 are elastically returned to their original positions, and the heads 26b support the top surface of the cap 18. In addition, the latch projections 26c of the snap hooks 26 are fitted into the latch grooves 18e of the cap 18. If the cap 18 is affixed by the snap hooks 26 in this manner, it is possible to securely prevent the fuse 10 from getting away. In particular, by the rigidly clamping force exerted by the snap hooks 26, it is possible to prevent the cap 18 from getting away from the base 14 by the explosive force generated when the fusible member 16 of the fuse 10 is disconnected. Furthermore, because the lead wires 12 of the fuse 10 are stably connected to the first vertical sections 32 and the bent pieces 42 by the elastic force exerted by the second guide pieces 40 of the receptacle terminal 30, the reliability of the inventive fuse device can be highly enhanced.

Meanwhile, if the fusible member 16 of the fuse 10 is disconnected and thus the fuse 10 is replaced with a new one, the operator can easily remove the fuse 10 from the holder 20 by outwardly opening by pressure the snap hooks 26 of the holder and then removing the cap 18 of the fuse 10 between the snap hooks 26. Because the new fuse 10 can be mounted in the holder 20 in a same manner as described above, the fuse 10 can be simply and conveniently replaced. Moreover, because the disconnection of the fusible member 16 is magnified by the lens 18d and viewed through the cap 18, the operator can easily identify whether the fusible member 16 is disconnected or not through the lens 18d by the naked eyes.

In the case of the fuse 10, the holder 120 and the receptacle terminals 130 of another embodiment shown in FIGS. 6 and 7, if the fuse 10 is inserted into the mounting space 128a from the upper side of the holder 120, the elastic stems 126a of the snap hooks 126 are opened outwardly while being elastically deformed, thereby allowing the smooth insertion of the fuse 10. The fuse 10 received within the mounting space 128a of the holder 120 cannot be moved in any direction due to the skirt 128 and cannot get out from the mounting space 128a because it is rigidly affixed by the clamping force exerted by the snap hook 126. Each lead wire 12 of the fuse 10 is smoothly inserted and interconnects the bent point between the first vertical section 132 the first guide piece 138 and the bent point between the bent piece 140 and the second guide piece 142 of the corresponding receptacle terminal 130 while being guided by the first and second guide pieces 138 of the corresponding receptacle terminal 130. Each receptacle terminal 130 with the first and second guide pieces 138, 142 being bent and outwardly inclined can be more easily fabricated, for example, by pressing a copper plate, as compared to a receptacle terminal 40 with the second guide piece 40 and the bent piece 42 being inwardly bent.

Although the present invention has been described above by reference several embodiments merely for illustrative purposes, the scope of the present invention is not limited to such preferred embodiments and an ordinary skilled one in the art may conceive various modifications, changes and substitutions can be made without departing from the scope and spirit of the present invention. Therefore, it shall be appreciated that such modifications, changes and substitutions fall within the scope of the present invention. In addition, although the inventive holder and receptacle terminals have been described as being adopted to connect a fuse, it is also possible to employ them for connecting an electronic component such as a light emission device which has a construction similar to that of a fuse.

### INDUSTRIAL APPLICABILITY

As described above, a fuse device according to the present invention has a construction in which receptacle terminals installed in a holder with a fuse removably provided is soldered to a printed circuit board, and lead wires of the fuse are connected to the receptacle terminals, whereby it is possible to simply and conveniently replace the fuse with a new one. In addition, the fuse is rigidly affixed by one or more snap hooks of the holder and a cap is efficiently prevented from getting out from a base of the fuse even if the fuse is disconnected, thereby highly enhancing the reliability. In addition, the disconnection of a fusible member can be easily identified through a lens formed on the cap of the fuse, thereby highly enhancing workability and convenience in terms of the replacement of the fuse with a new one.

What is claimed is:

1. A fuse device comprising:
a fuse having an insulating base, a pair of lead wires affixed to the base in a spaced-apart relationship with each other, a fusible member interconnecting the lead wires and a cap coupled to the base for enclosing the fusible member;
a holder for removably retaining the fuse in place, the holder having a pair of through-holes in alignment with the lead wires of the fuse; and
a pair of receptacle terminals respectively fitted into the through-holes of the holder for receiving the lead wires of the fuse, each of the receptacle terminals having a leg connectable to a printed circuit board.

2. A fuse device as recited in claim 1, wherein the holder has a pair of snap hooks and the cap has a pair of latch parts engaged with the snap hooks.

3. A fuse device as recited in claim 1, wherein the cap has a lens for magnifying the fusible member.

4. A fuse device as recited in claim 2, wherein the holder has a skirt for receiving at least a part of the fuse.
